(19) United States
(12) Patent Application Publication
(10) Pub. No.: US 2016/0280300 A1
(43) Pub. Date: Sep. 29, 2016

(54) COMBINED DEVICE FOR POWER GENERATION, POWER REGULATION, AND REMOVABLE POWER STORAGE FOR A BICYCLE

(71) Applicant: SIVA CYCLE LLC, Oakland, CA (US)

(72) Inventor: Aaron LATZKE, Emeryville, CA (US)

(21) Appl. No.: 14/778,034

(22) PCT Filed: Mar. 21, 2014
(86) PCT No.: PCT/US2014/031407

§ 371 Date: Sep. 17, 2015

Related U.S. Application Data
(60) Provisional application No. 61/804,381, filed on Mar. 22, 2013.

(51) Int. Cl. B62J 6/12; H01M 2/10; B62J 6/10; H01M 10/42

(52) U.S. Cl. CPC B62J 6/12; H01M 10/4257; H01M 2/1077; H01M 2/1083; B62J 6/10; H01M 2010/4271

(57) ABSTRACT

A combined device for power generation, power regulation, and removable, rechargeable, power storage for a bicycle comprising of: a main housing, a primary drive gear located inside the main housing, said primary drive gear positioned on a bicycle such that the turning of the bicycle wheel turns the primary drive gear, a gear drive system having a rotor gear, an electronics module containing a plurality of electronic components to convert electrical input forms into a electrical output forms of preference, a rechargeable battery pack, a power output jack located on the removable battery pack housing, a hub mount that is clamped between a bicycle hub and a bicycle frame dropout by a clamping mechanism.

### CROSS-REFERENCE TO RELATED APPLICATIONS

This application claims priority from U.S. Provisional 61/804,381 titled Combined Device for Power Generation, Power Regulation, and Removable Power Storage for a Bicycle, filed on Mar. 22, 2013

### BACKGROUND OF THE INVENTION

The present invention is in the technical field of electricity generators.

More particularly, the present invention is in the technical field of electricity generators for bicycles.

Existing generators for bicycles fall into three categories. First, external sidewall generators generate power by utilizing the friction between the sidewall of the bicycle wheel and the generator's rotor contact wheel to cause the rotation of the rotor relative to the stator. Second, hub generators generate power by utilizing the rotation of the bicycle wheel to cause the rotation of the rotor of the generator relative to the stator. Third, bicycle axel mounted, external generators generate power by utilizing the mechanical transfer of the rotation of the wheel to cause the rotation of the rotor of the generator relative to the stator, which is located off the axis of the bicycle axle.

The following is a list of the aforementioned bicycle generator categories and their observed shortcomings:

1. Sidewall Bicycle Generator
a. Friction based transfer of motion is susceptible to environmental (such as weather) and hardware (such as tire rubber compound) based variables that greatly affect its ability to consistently perform
b. Accurate alignment is needed for efficient transfer of motion and consistent performance
c. Generator body or mount typically extends outside the confines of the bicycle frame, increasing the chance of damage or destruction by impact, also increases likelihood of generator being knocked out of alignment
d. The electrical output is not regulated for use with personal electronics and requires additional accessories that require extensive knowledge to implement.
e. There is no electrical storage (battery) available to capture generated power for later use.

2. Hub Bicycle Generator
a. Due to the nature of this device having to serve as the entity of the wheel center with the necessary precision and robustness, cost is typically high.
b. Cost to the consumer is further increased by the need to then build or assemble a wheel around the generator hub, a highly skilled task.
c. By being directly linked to the rotational speed of the bicycle wheel and given requested performance at low bicycle velocities, the generator becomes heavy for the desired power output at certain speeds.
d. The electrical output is not regulated for use with personal electronics and requires additional accessories that require extensive knowledge to implement.
e. There is no electrical storage (battery) available to capture generated power for later use.
f. There is no way to disengage the generator from the bicycle when not in use. This means that the inherent drag of the core loss of the generator stator will always be present to the user, taxing their ride even when the generator is not creating electrical power.

3. Existing External, Bicycle Axel-mounted Generators
a. If there is electrical storage, it is not detachable for use away from bicycle.
b. Output for external powering of electronic devices limited to a single output value and format.
c. No auxiliary method of charging the electrical storage device. Only power from the generator is available as a charging method.
d. Does not accept any other method of power input for output options other than the input from the integrated generator or onboard battery. Only input from the integrated generator can charge the onboard battery or create an output to power external electronics.
e. Generator is not detachable from bicycle for protection from theft.
f. Does not fit within the confines of the bicycle frame creating risk of damage or destruction by contact with surrounding environment.
g. Uses direct interference or mounting to the rotating input wheel spokes in order to draw rotational energy that, in turn, spins the generator. This risks the following: damaging of the turning entity spokes in an event of rapid acceleration or deceleration; damaging of the internal components of the generating device during rapid acceleration or deceleration; limits mounting opportunities of the generating device to those turning entities that have spokes of a certain spacing, number, and size.

### SUMMARY OF THE INVENTION

The present invention intends to improve the ease of use of bicycle generators for the consumer by simplifying the method of installation, creating an integrated, detachable powering option for electronic devices, integrating rear lights, and utilizing generator technologies that allow for a more compact powering production; in turn, these improvements allow the generator to fit within the confines of the bicycle frame envelope protecting it against impact.

A primary objective of the present invention is to integrate the generator and power electronics needed to power lights and devices within the housing of the generator so that no additional products or knowledge is necessary for converting the generated power into desired usable outputs. This integration of power electronics overcomes the shortcomings of prior art outlined above in 1d and 2d.

Another primary objective of the present innovation is to utilize direct interfacing with the rotating input entities of the bicycle wheel to transfer motion to the rotor of the generator. This eliminates aforementioned variables affecting prior art performance outlined above in 1a.

The present innovation intends to provide an integrated, detachable battery for the consumer to utilize converted kinetic energy when the bicycle is not in use, or is stopped. This feature of the innovation greatly enhances the flexibility of using the power generated which overcomes prior art's shortcoming outlined in 3a.

An additional objective of the innovation is to provide enhanced power electronics in order to allow the integrated, detachable battery to be charged via auxiliary power sources (such as a conventional wall outlet) and not only via the integrated generator. The auxiliary power option overcomes prior art's shortcoming outlined above in 3c.

A further objective of the innovation is to provide multiple output voltages allowing for simultaneous charging of the integrated, detachable storage device, charging of attached consumer devices (such as portable electronics), and powering external lights. This addition of multiple power output values and formats overcomes the shortcoming of prior art outlined above in 3b.

Another objective of the innovation is to provide an input port and functionality within the electronics so that additional power inputs beyond the integrated generator or battery pack can be converted to a preferred electrical output. This feature overcomes the shortcomings of prior art outlined in 3d.

Another objective of the innovation is to allow the generator to be removed easily from the mount with a quick release mechanism, protecting against theft of the device. This easy removability feature overcomes the shortcoming of prior art outlined above in 3e.

An additional objective of the innovation is to provide integrated rear lighting in order to improve rider safety by incorporating lights that do not require replaceable batteries. The lights are engaged by light sensors or a switch.

Another objective of the innovation is to provide a rotational input mechanism that can mount to any spoke configuration of the turning input entity that doubles as a clutch mechanism for protection against rapid acceleration and deceleration of the rotating input entity. This allows increased versatility of the innovation, allowing it to mount quickly and without tools and transfer rotational energy from a wide variety of rotating input surfaces. The clutch mechanism of the innovation protects both the rotating entity from damage during rapid acceleration or deceleration, as well as the internal components of the innovation itself. This objective addresses the shortcomings of prior art outlined above in 3g.

### BRIEF DESCRIPTION OF THE DRAWINGS

FIG. 1 is a perspective view of the present invention;

FIG. 2 is an exploded view of the present invention showing the main housing 30, the integrated, detachable battery 40, and a rotational input mechanism 50;

FIG. 3 is a perspective view of the present invention's main housing assembly 30;

FIG. 4 is an exploded view of the present invention's main housing assembly 30;

FIG. 5 contains perspective views of the present invention's mechanical assembly 60;

FIG. 6 contains perspective and lateral views of the present invention's geartrain 61;

FIG. 7 is an exploded view of a typical power module 70;

FIG. 8 is an exploded view of the present invention's rotational input mechanism 50;

FIG. 9 is a cross-section of the present invention's rotational input mechanism 50 in extended form;

FIG. 10 is a cross-section of the present invention's rotational input mechanism 50 in contracted form;

FIG. 11 is a perspective view of the present invention mounted on a bicycle engaging the rotating input entity's spokes;

FIG. 12 contains perspective views of the present invention's integrated, detachable battery 40;

FIG. 13 is an exploded view of the present invention's integrated, detachable battery 40;

FIG. 14 is a lateral view of the present invention mounted within the confines of a bicycle frame;

FIG. 15 is a posterior view of the present invention mounted within the confines of a bicycle frame;

FIG. 16 is a perspective view of the present invention with generating core and electronics disengaged from the rotating input;

FIG. 17 is a posterior view of the present invention showing integrated lights.

### DETAILED DESCRIPTION OF THE INVENTION

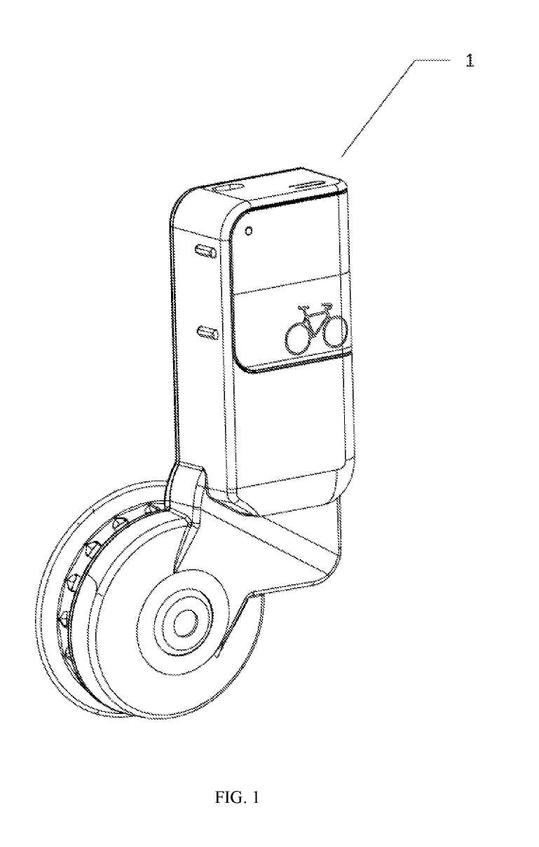

Referring now to the invention in more detail, in FIG. 1 there is the present invention 1 in its complete form, uninstalled on a bicycle.

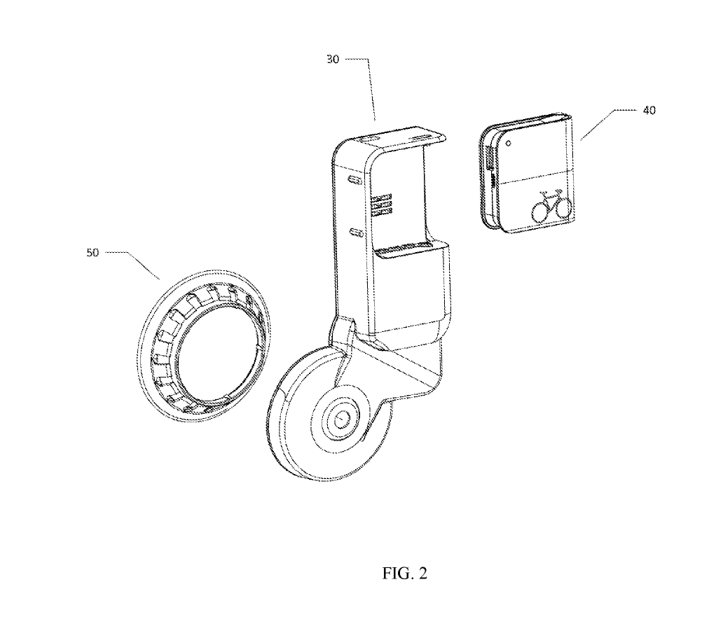

Referring to FIG. 2, we see that the present invention 1 in complete form is comprised of three sub-assemblies immediately removable: the main housing 30, the detachable battery 40, and the rotational input mechanism 50.

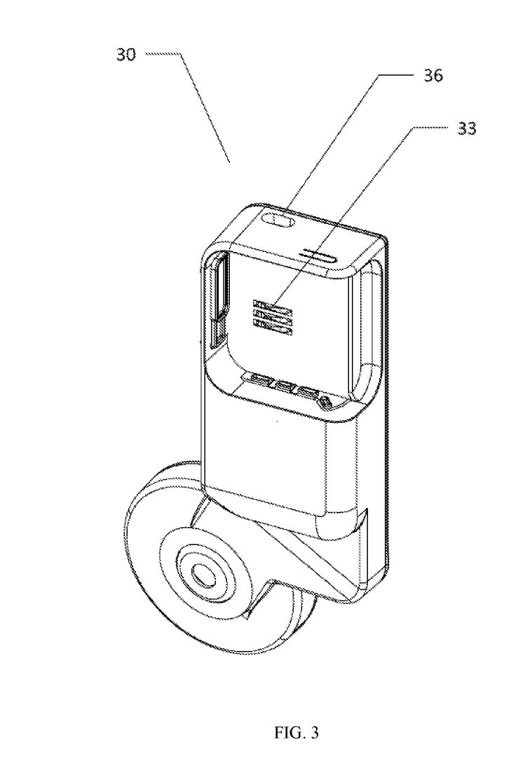

Referring to FIG. 3, we see the main housing 30 in complete form, of note are the battery contacts 33, and housing power outlet 36.

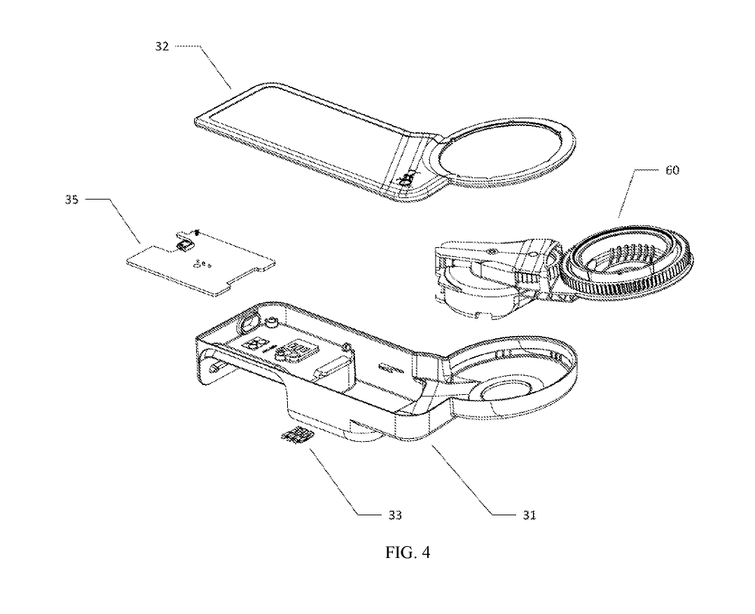

Referring to FIG. 4, we see the main housing in exploded form, of note is the mechanical assembly 60, housing shell 31, housing lid 32, battery contacts 33, and generator ECU 35.

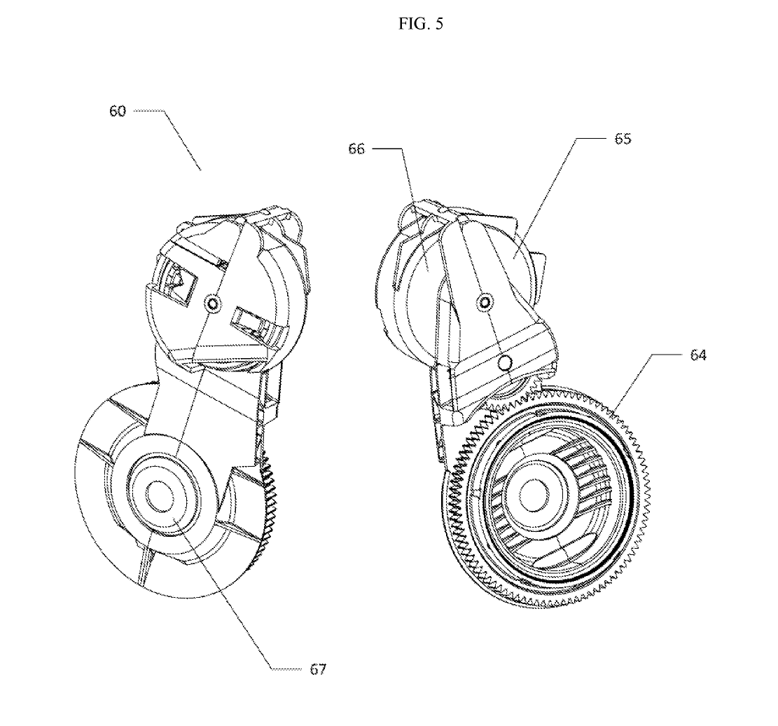

Referring to FIG. 5, we see the mechanical assembly 60 from the front and rear views. Of note is the primary drive gear 64, the gear train housing right 65, the gear train housing left 66, and the frame clamp 67.

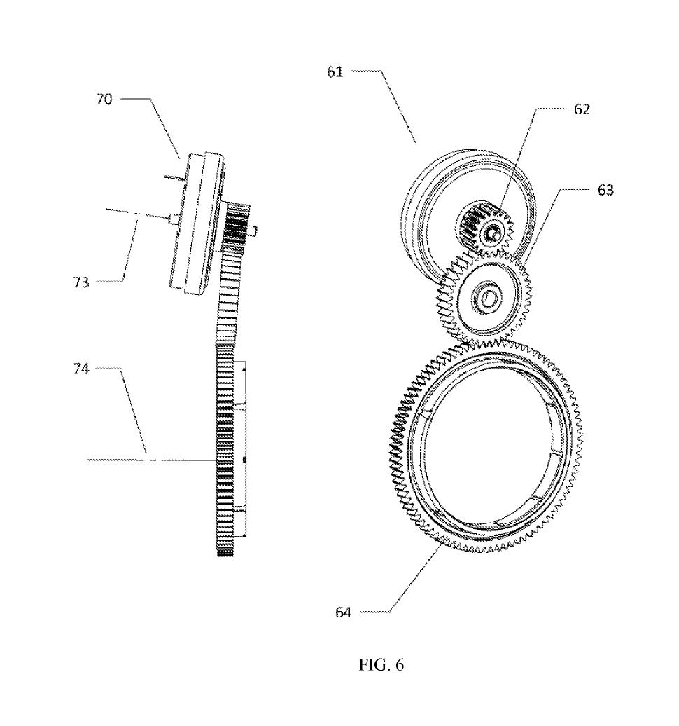

Referring to FIG. 6, we see the gear train assembly 61, which consists of the rotor gear 62, idler gear 63, and primary drive gear 64. The rotor gear 62 is attached to the rotation input 71 of power module 70. We also see that the power module 70 has a gen axis 73, and the primary drive gear 64 has a drive axis 74. Based on the gear system chosen, gen axis 73 and drive axis 74 may be 0 degrees to 180 degrees, and exist within the same plane or in separate, intersecting planes.

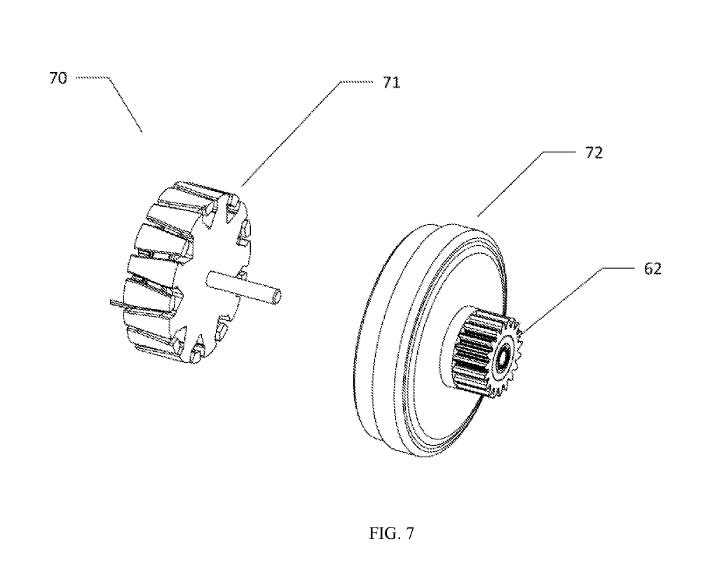

Referring to FIG. 7, we see the power module 70 that consists of the rotation input 71 and stationary mount 72. Power module 70 outputs electrical power (Voltage*Current) from a kinetic rotational input.

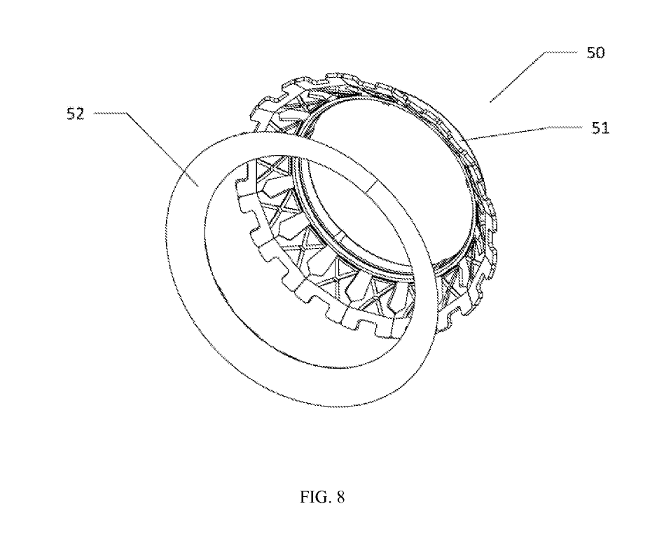

Referring to FIG. 8, we see the rotational input mechanism 50, which consists of the skeleton 51 and elastomer ring 52.

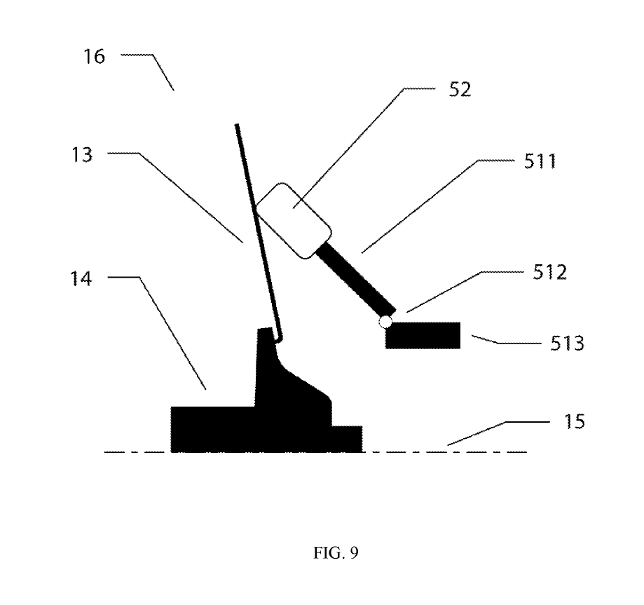

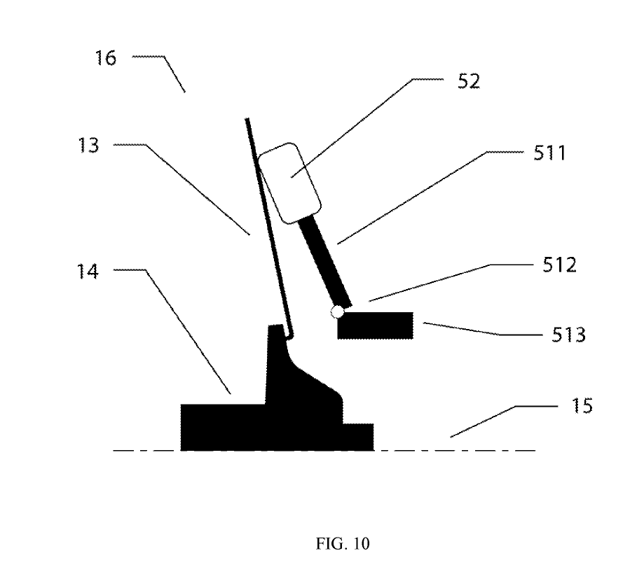

Referring to FIG. 9 and FIG. 10, we see a cross-sectional diagram of the rotational input mechanism 50 interfacing with a rotating input entity 16, comprised of a rotating surface 13 which is connected to a hub 14, both of which spin along an axis 15. The skeleton 51 is comprised of a rigid member 511 that connects via a hinged connection 512 to a base ring 513. The base ring is concentric to axis 15. There are multiple rigid members 511 along the circumference of base ring 513, all the way around as shown in FIG. 7. The elastomer ring 52 connects to the rigid members 511 along the unhinged ends with a relaxed diameter that yields an angle between the rigid members 511 and base ring 513. As the axial distance between the rotating surface 13 and the base ring 513 decreases, the angle will decrease between rigid members 511 and base ring 513 and the diameter of elastomer ring 52 will increase. The increase in diameter of elastomer ring 52 will stretch the elastomer and will increase the normal force of where the elastomer ring 52 contacts rotating surface 13, increasing the available torque transfer possible as long as a coefficient of static friction exists and is greater than zero between the elastomer ring 52 and the rotating surface 13.

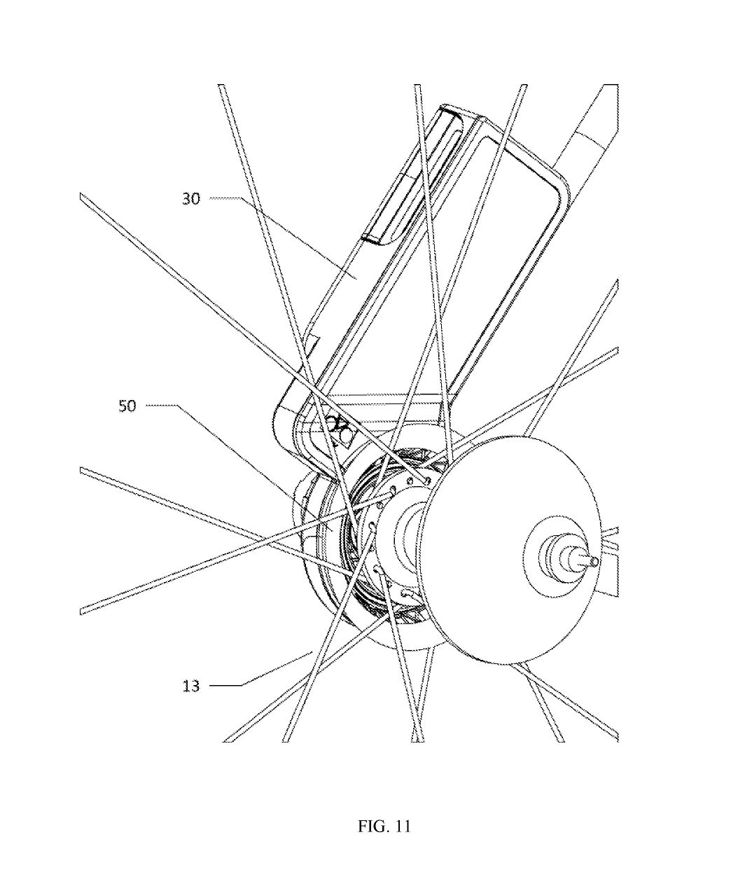

Referring to FIG. 11, we see the main housing 30 with rotational input mechanism 50 installed, the assembly of the two mounted on the bicycle and contacting the wheel spokes 13. This would be a typical setup on a bicycle of how the rotational input mechanism 50 transfers rotational energy from the rotating input entity 16.

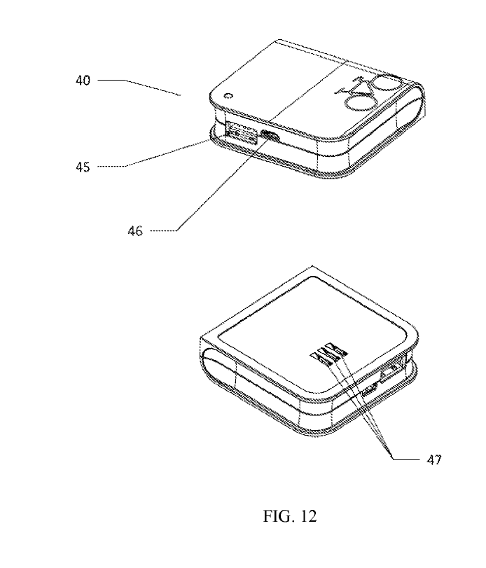

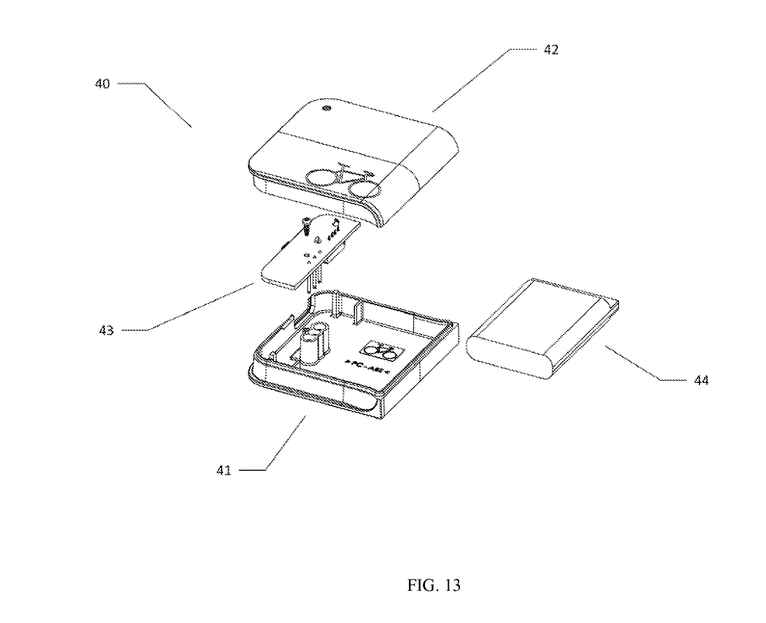

Referring to FIG. 12 and FIG. 13, we see the detachable battery 40 in perspective and exploded views. Of note is the bottom housing 41, the top housing 42, the battery ECU 43, the battery cell 44, the battery power outlet 45, the charge port 46, and the generator pins 47.

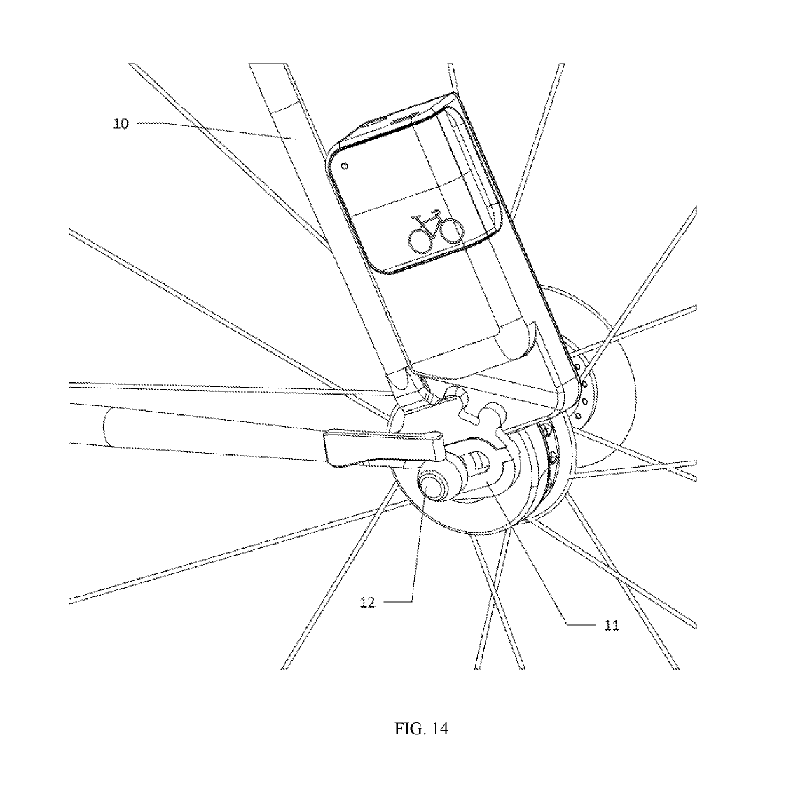

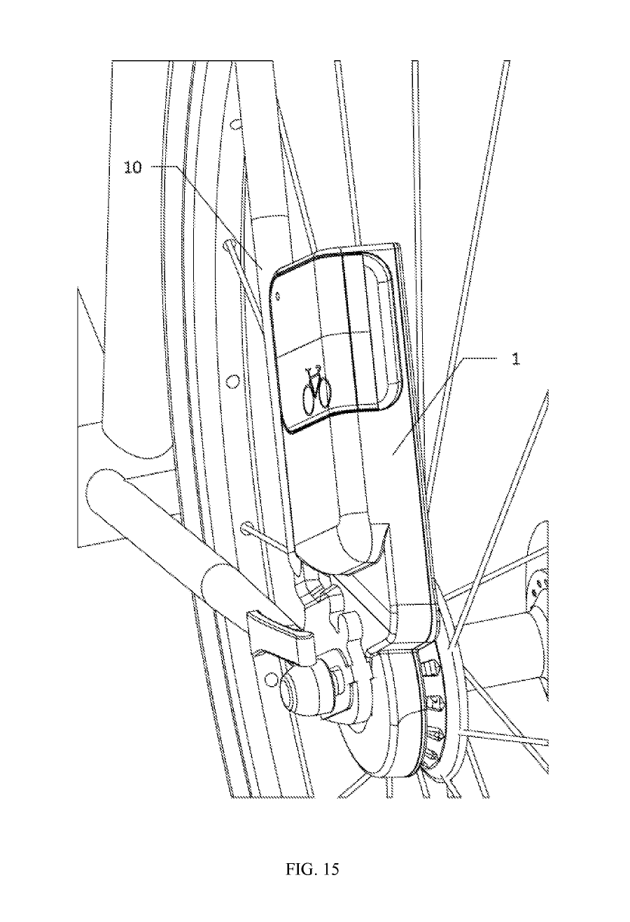

Referring to FIG. 14 and FIG. 15, we see the present invention 1 installed on a bicycle frame 10, via the frame dropout 11 and held in place by the axle fastener 12. Here we see that the present invention 1 is configured such that it is located within the confines of bicycle frame 10.

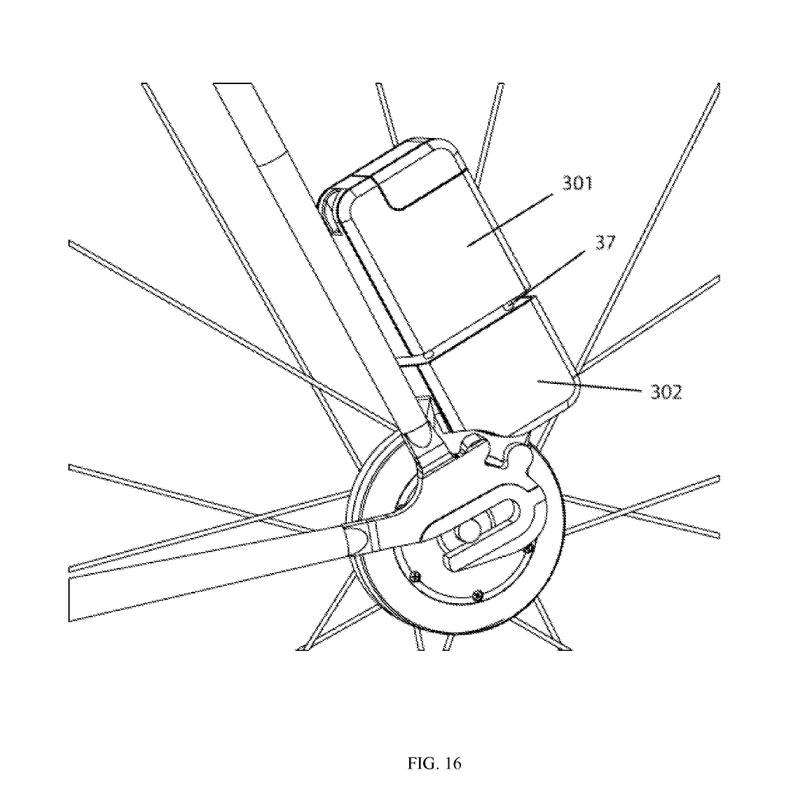

Referring to FIG. 16, we see the present invention 1 in a disengaged state, whereas the main housing is split into upper main housing 301 and lower main housing 302 via the housing rails 37.

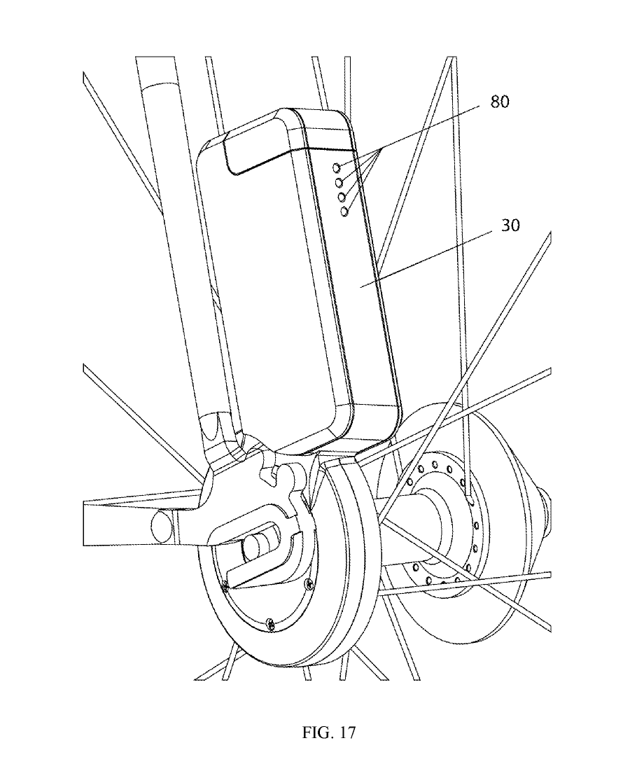

Referring to FIG. 17, we see the lights 80 installed within the main housing 30.

The present invention 1 is mounted on a bicycle by clamping frame clamp 67 in between the frame dropout 11 and hub 14 with the axle fastener 12. By doing so, the rotational input mechanism 50 is brought into contact with the rotating input entity 16, here presented as a bicycle wheel, more specifically, in contact with the rotating surface 13, here presented as bicycle spokes. As the present invention is drawn onto the hub 14, the elastomer ring 52 is pressed into the rotating surface 13 with a certain force normal to the rotating surface 13 and elastomer ring 52 interface, creating shear friction between the elastomer ring 52 and the rotating surface 13. This shear friction allows for the transmission of a force about the axis 15, thus transferring torque, and thus rotational energy, from the rotating input entity 16 to the rotational input mechanism 50. The normal force between the rotating surface 13 and the elastomer ring 52 can be adjusted by the parameters of the elastomer ring 52 (material, durometer, thickness, surface texture, etc) and/or the length of the rigid members 511, and/or the characteristics of the hinged connection (smooth rotating or with friction, using a hinge pin or a live hinge to name a few). This adjustment can be used to create a maximum transmitted torque where, when exceeded, the rotational input mechanism 50 will slip in relation to the rotating surface 13. This can be used to protect both the rotating surface 13 from damage, or the downstream mechanics that the rotational input mechanism 50 is driving, in this case, the mechanical assembly 60, or more specifically, the gear train assembly 61.

The rotational input mechanism 50 is connected to the primary drive gear 64 in a rigid fashion such that they rotate in unison about the same axis 15. As the primary drive gear 64 spins, it turns idler gear 63, which turns rotor gear 62, which is connected to the rotation input 71 of power module 70. Referring to FIG. 6, primary drive gear 64, idler gear 63, and rotor gear 62 can be comprised of gear systems that will allow for parallel or non-parallel axes, either within the same plane, or within transverse planes. Presented in FIG. 6 is a beveloid gear system that allows for non-parallel gear shafts while being in the same plane. Other configurations can be created by the use of other gear systems, such as helical, worm, bevel, or hypoid to name a few.

The gear train assembly 61 can also allow for a mechanical advantage between the primary drive gear 64 and the rotor gear 62. This advantage can be in the form of an overdrive or a gear reduction, depending on the pitch diameters of the various gears. The gear ratio between the primary drive gear 64 and rotor gear 62 can be 1:1 as well, using the idler gear 63 as only a directional shift operator between gen axis 73 and drive axis 74, or to gain distance from the drive axis 74 and the power module 70.

The gear train assembly 61 can also have fewer gears (two) or more gears (infinite) to achieve these desired characteristics of shaft angle, gear ratio, etc.

Furthermore, the gear train assembly 61 does not have to be limited to gears. They can be comprised of smooth wheels with a frictional surface to transmit torque, or other power transmission systems such as belt drive systems that employ pulleys.

The rotational energy that is transmitted to the rotation input 71 of power module 70 causes it to spin relative the stationary mount 72, thus creating electrical power from the kinetic input.

The primary drive gear 64, idler gear 63, rotor gear 62 and connected power module 70 are held in correct relation to each other by gear train housing right 65 and gear train housing left 66. This makes up the majority of mechanical assembly 60. Mechanical assembly 60 is contained within main housing 50 as shown in FIG. 4, along with generator ECU 35. Generator ECU 35 contains electronics. The electrical power that is generated by power module 70 is routed to generator ECU 35 where it is converted into an electrical format of preference. Some examples, but not limited to, is a USB format, which is 5 VDC with current up to 2.1 A, or 110 VAC for use with electronics that work with line voltages. All necessary power generation and converting is done within the confines of the housing shell 31 and housing lid 32.

Generator ECU 35 can also contain sensors such as, but not limited to, accelerometers, GPS sensor, pressure sensors, moisture sensors, or temperature sensors. Communication modules may be present such as, but not limited to, Bluetooth, cellular, WiFi, or any other type of wireless communication capability. Generator ECU 35 can also contain lights or noise making devices like speakers or piezos, or any combination thereof.

The generator ECU 35 transfers the converted power to one of two places: the housing power outlet 36 or the battery contacts 33. The power can be sent to the housing power outlet 36 or the battery contacts 33 concurrently or one at a time. The power can be controlled or uncontrolled in how it is divided between housing power outlet 36 and battery contacts 33; controlled meaning the generator ECU uses electrical techniques to limit the current regardless of the electrical load, uncontrolled meaning the current flow is determined by the electrical loads of housing power outlet 36 relative to the battery contacts 33.

The detachable battery 40 mounts in the main housing 30. When detachable battery 40 is mounted in main housing 30, the battery contacts 33 are in contact with generator pins 47, which make an electrical connection between the battery ECU 43 and generator ECU 35. The electrical connection can allow transfer of electrical power, data communication, or any type of electrical signal that can be conductively transmitted. The detachable battery 40 can operate while installed in the main housing 30, supplying power from battery cell 44 through generator pins 47 to battery contacts 33 into generator ECU 35 and out through housing power outlet 36.

The battery ECU 43 contains electronics that can use input electrical power from generator pins 47 to charge battery cell 44. Battery ECU 43 contains electronics that can discharge the battery cell 44 through battery power outlet 45 in an electrical format of preference. That format can be, but not limited to USB format (5 VDC) or line format (110-240 VAC) that can be discharged through the battery power outlet 45.

The battery cell 44 can be, but is not limited to, a rechargeable battery of the following types: lithium-ion, lithium-polymer, Ni—Cd, Ni-Mh, or lead-acid.

The detachable battery 40 may also contain non-rechargeable battery cell(s) 44 that are removable from bottom housing 41 and top housing 42. This allows the conversion of the electrical output of battery cell 44 into the preferred electrical format for non-rechargeable batteries.

The bottom housing 41 and top housing 42 may be configured in such a way as to allow easy installation and removal of removable rechargeable battery cell(s) 44. This would allow recharging of modular rechargeable batteries such as AA sized Ni-MH batteries, for example. When the removable battery cell 44 is charged, it can be removed from the detachable battery 40, and new, depleted, removable battery cell(s) 44 can be installed to receive charge.

Electrical power can also be input to battery ECU 43 via charge port 46, where electrical power of a format of choosing can be input to the battery ECU 43 to charge the battery cell 44 or power electronics contained within battery ECU 43. The electrical power could come from alternating-current sources or direct-current sources, from raw inputs like a generator or solar panel, or from conditioned inputs like from a wall outlet or USB power source.

Battery ECU 43 can also contain sensors such as, but not limited to, accelerometers, GPS sensor, pressure sensors, moisture sensors, or temperature sensors. Communication modules may be present such as, but not limited to, Bluetooth, cellular, WiFi, or any other type of wireless communication capability. Battery ECU 43 can also contain lights or noise making devices like speakers or piezos, or any combination thereof.

Detachable battery 40 can also contain additional ports beyond battery power outlet 45 and charge port 46 so that multiple power inputs of different format connectors may feed into battery ECU 43 and be converted to the preferred format.

There may be more than one integrated battery cell 44 within the present invention 1, whereas all are removable and none are fixed, one is removable and the remainder are fixed, or any combination therein.

Referring to FIG. 13 and FIG. 14, we see how the present invention 1 is situated within the confines of the bicycle frame 10. This is due to the type of power module 70, and gear train assembly 61 that is chosen to direct the rotational motion into a preferred form. This is also due to having all necessary components needed for power generation, conversion, and delivery enclosed within one housing, the main housing 30.

Referring to FIG. 15, the power module 70, generator ECU 35, and the detachable battery 40 are contained within, or attached to, the main housing upper 30a. The main housing upper 30a can slide away from the main housing lower 30b along the housing rails 37 to disengage the power module 70 from the gear train assembly 61. By disengaging the main housing upper 30a, the user can reduce the inherent drag of power module 70 if it is an electromagnetic device for cases where electrical power is not wished to be produced. Furthermore, the disengagement method may also be achieved by incorporating a hinge between main housing upper 30a and main housing lower 30b so that a hinging action is achieved to create separation. By removing the main housing upper 30a from the main housing lower 30b completely, theft of the total product is deterred similar to how car stereos have removable interfaces to deter theft of the total stereo.

Referring to FIG. 16, the main housing 30 can also contain lights facing in any direction, here shown facing towards the rear of the bicycle. These lights can be activated by motion, a light sensor, a button in the housing, a remotely located wired button, or wirelessly via a wireless communication protocol. There could be one light or multiple lights, one color or multiple colors.

The advantages of the present invention include, without limitation,
Incorporated power electronics greatly facilitate charging and electricity usage for the generator's owner.
An on-board, rechargeable, detachable battery pack for storing power for use on or off the bicycle provides flexible power options.
An on-board, detachable battery pack where the battery cells are located on the exterior of the battery pack, and are of common sizes (AAA, AA, etc.) for use in other appliances (flashlight, stereo, etc.)
The drive train is configured to keep the entire device within the confines of the bicycle frame to protect it against damage of impact.
The housing with the generator and parts inside can be disengaged to reduce resistance or completely removed to be theft resistant
The device is easy to install for non-skilled persons and easy to remove for modular use.
Low input speeds at light weight via the mechanical advantage of the gear train (prior art depends on high input speeds to generate significant power)
Varying input speeds (power electronics allow steady voltage and therefore power despite varying input speeds)
Incorporated rear lighting with sensors to ensure safety of the rider when riding in the dark

In broad embodiment, the invention is a device that allows conversion of kinetic energy into a conditioned electrical output—of the type, but not limited to, USB—so to be widely available to a multitude of electronic devices as an energy source. Furthermore, the invention allows for power to be generated while in motion, have energy stored within its confines, and then allow for this storage of energy to be removed and used in application away from the main body and location of the invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A combined device for power generation, power regulation, and removable, rechargeable, power storage for a bicycle comprising of:
a. a main housing, having an inside and an outside, said main housing holding inside a power module, said power module having a power electronics, said power electronics receiving electrical energy from a rotating entity.
b. a primary drive gear located inside the main housing, said primary drive gear positioned on a bicycle having a bicycle wheel with an axle, wherein the primary drive gear is concentric about the axle of said bicycle wheel, and a rotational motion transfer mechanism mounted to the primary drive gear such that the turning of the bicycle wheel turns the primary drive gear; and
c. a gear drive system having a rotor gear, wherein the gear drive system has a mechanical advantage to create a change in a rotational speed, whereas the rotational speed entered at the primary drive gear is multiplied by a gear ratio as it passes along the gear drive system, leaving the rotor gear spinning at a different rate than the primary drive gear by a fixed ratio; and
d. said main housing, in such a form as to be within the confines of a bicycle frame so as not to be overly exposed to possible impact and damage from the environment; and
e. an electronics module with a circuit board, said electronics module located within the main housing, and said electronics module connected to the power module via a conductive medium, containing a plurality of electronic components to convert electrical input forms into a electrical output forms of preference; and
f. a rechargeable battery pack, said rechargeable battery pack having a certain capacity and voltage, wherein the rechargeable battery pack has a cell or multiple cells, said rechargeable battery pack having a connection to the electronics circuit board by a conductive medium and mounted within a removable housing such that the rechargeable battery pack can be installed or removed from the main housing; and
g. a power output jack located on the removable battery pack housing, connected to the battery electronics, such that a stored energy of the battery cell contained within the removable battery pack housing can be output to power an external device; and
h. a power output jack located on the outside of the main housing, said power jack connected to the electronics module such that an external device can be powered by either the power module by the power electronics, or by the onboard battery storage by the power electronics; and
i. a hub mount that is clamped between a bicycle hub and a bicycle frame dropout by a clamping mechanism, said clamping mechanism as what keeps the hub fixed to the frame in the absence of the invention.

2. The combined device for power generation, power regulation, and removable, rechargeable, power storage for a bicycle mounted between the frame and hub of the bicycle wheel as in claim 1, whereas the gear drive system employs a gear system that allows for non-parallel shaft angles between the rotational energy input axis and the power generation module axis.

3. The combined device for power generation, power regulation, and removable, rechargeable, power storage for a bicycle mounted between the frame and hub of the bicycle wheel as in claim 1, whereas the rotational input to the primary drive gear occurs via an elastomer rotational transfer system comprised of:
j. An elastomer traction band supported on radially extending, hinged rigid members to transfer rotational energy from the rotational input source to the primary drive gear; and
k. A surface profile, finish, or texture of the traction band to vary the slip torque, or when the traction band will slip relative the rotational input source; and
l. A thickness and width of the traction band to vary the normal force of the traction band to the rotational input surface, in turn, varying the slip torque, or when the traction band will slip relative the rotational input source; and
m. A rigid base for which the traction band is supported on, of varying lengths to vary the rotational input source distance and configuration in relation to the primary drive gear.

4. The combined device for power generation as in claim 1, wherein the main housing containing the power module, electronics module, onboard battery storage, and power jack can be disengaged or completely removed from the bicycle using a separating mechanism thereby separating the upper housing containing the generating module, the power electronics, and onboard battery storage from the lower main housing containing the hub mount, gear train assembly, and the rotational transfer system which will stay mounted to the bicycle.

5. The combined device for power generation as in claim 1, wherein the removable battery pack contains a battery, a plurality of battery electronics, and charge port so to be capable of being charged by an external power source when removed from or installed in the main housing unit.

6. The combined device for power generation as in claim 1, wherein the rechargeable battery pack contains provisions such that the cells are modular, wherein the cells are located on the exterior of the rechargeable battery pack housing for accessibility to be installed or removed without a tool.

7. The combined device for power generation as in claim 1, wherein the device contains a GPS sensor.

8. The combined device for power generation as in claim 1, wherein the device contains a wireless data transmission capability.

9. The combined device for power generation as in claim 1, wherein the device has a cellular communication capability.

10. The combined device for power generation as in claim 1, wherein the device has one or more accelerometers.

11. The combined device for power generation as in claim 1, wherein the wherein the device has a physical sensor.

12. The combined device for power generation as in claim 1, wherein the device has a light sensor.

13. The combined device for power generation as in claim 1, wherein the wherein the device has a moisture sensor.

14. The combined device for power generation as in claim 1, wherein the device has one or more lights.

15. The combined device for power generation as in claim 1, wherein the wherein the device has a speaker.

16. The combined device for power generation as in claim 1, wherein the wherein the device has additional input ports.

17. The combined device for power generation as in claim 1, wherein the device has additional output ports.

18-20. (canceled)
